(19) United States
(12) Patent Application Publication
(10) Pub. No.: US 2004/0154717 A1
(43) Pub. Date: Aug. 12, 2004

(54) Automobile tire traction strap

(76) Inventor: Andrew B. Gray, Loudon, NH (US)

Correspondence Address: Andrew B. Gray, Jr., 7010 Pleasant Street Extension, Loudon, NH, 03307, US

(21) Appl. No.: 10/364,485

(22) Filed: Feb. 11, 2003

(51) Int. Cl. B60C 11/00

(52) U.S. Cl. 152/213 R

(57) ABSTRACT

A removable strap which mounts transversely to a tire through a wheel fello is threaded through and removably secures a supplemental traction-providing sleeve to the tread of a tire. The sleeve has a generally rectangular cross-section, with one side adapted to engage the tire tread surface and the opposite side adapted to engage the road surface. The opposing ends of the sleeve are bent at an acute angle toward each other to provide mechanical advantage to hold the sleeve securely in place and to reduce stress on the strap. The road surface engaging side of the sleeve includes a traction-providing surface which is integral with or permanently affixed to the sleeve. The strap passes through the interior portion of the sleeve and around the tire through a wheel fello. The strap has two opposing ends which are removably secured together, such that the strap securely affixes the sleeve to the tire.

### FIELD OF THE INVENTION

The present invention relates to devices which are installed on motor vehicles tires to increase traction. More particularly, the present invention relates to a traction strap which can be simply and easily installed and removed as needed, for example, in the event of an emergency when the motor vehicle is stuck in slippery or otherwise low traction conditions.

### BACKGROUND OF THE INVENTION

Motor vehicles are able to negotiate surfaces provided the tires have sufficient traction. Ordinarily, this is not a problem on dry or wet pavement. However, winter snow and ice may cause pavement to become extremely slick, whereupon the tires of the drive wheels of the vehicle may be unable to gain sufficient traction to allow the motor vehicle to move off from the slick area, thereby resulting in the motor vehicle becoming stuck. Additionally, when a motor vehicle is driven on an unpaved surface, the ground may be loose and not provide adequate traction, such as may happen in very sandy or waterlogged areas. These conditions are most likely to affect rear wheel drive vehicles, but they may also happen to front and all wheel drive vehicles. Accordingly, it would be beneficial to provide some form of auxiliary traction device which can be readily and removably affixed to the tires of the drive wheels should a situation occur wherein the vehicle has become stuck, or is likely to become stuck.

Several means for the temporary enhancement of automobile tire traction are known. For example, tire chains and cables such as those shown in U.S. Pat. No. 4,391,315 to Jacobson and U.S. Pat. No. 4,825,923 to Blankenship et al. are well known. Devices of the type shown in those references suffer several disadvantages, however. For example, in addition to being cumbersome, difficult, and sometimes even dangerous to install, they also typically require, because they entirely encase the circumferential traction surface of the tire to which they are attached, that the vehicle be moved or jacked up to complete installation. Moreover, the installation process usually requires the installer to lie and/or kneel down on the ground, which, in the conditions in which such devices are typically installed, can result in significant discomfort and possibly danger. The complexity of such devices also drives production costs up, and increases the possibility of failure when the devices are in use.

Thus there exists a need for an emergency vehicle traction device for providing improved traction to automobiles requiring temporary traction improvement in a wide variety of situations. In particular, there is a need for a device adapted for providing temporary, improved traction to an automobile or other wheeled vehicle stuck in mud, snow, ice, or other traction hazard, which is easy, quick, and convenient to install, and which is economical to produce and maintain. There is also a need for such a device which may be installed without tools and which will not damage the wheel or vehicle to which it is attached. There is a further need for such a device which can be installed on the wheel of the vehicle without moving or jacking up the vehicle.

### SUMMARY OF THE INVENTION

The present invention is concerned with supplemental tire traction devices. Specifically, the invention relates to a removable tire traction strap which mounts transversely to the tire through a wheel fello. In accordance with the present invention there is provided a tire traction strap adapted to be affixed to a tire mounted upon a wheel, the tire having a pair of opposed side walls and a peripheral road-contacting outer circumferential surface. The tire traction strap of the present invention comprises at least two cooperative components, a sleeve having a traction-providing surface which mounts to the tire and a strap which passes through the interior portion of the sleeve and around the tire through a wheel fello. The strap has two opposing ends are removably secured together, such that the strap securely affixes the sleeve to the tire.

A primary object of the present invention is to provide a tire traction strap which is easy, quick and convenient to install, and which is economical to produce and maintain.

It is a further object of the invention to provide a tire traction strap which can be installed or removed as needed by an individual user in a matter of minutes, without specialized tools or the need to jack up the vehicle.

It is a further object of the invention to provide a tire traction strap suitable to provide temporary traction improvement in a wide variety of situations.

It is a further object of the invention to provide a tire traction strap which will not damage the wheel to which it is attached.

It is a further object of the invention to provide a tire traction strap which is compact and lightweight for convenient storage.

The novel features which are considered characteristic for the invention are set forth in the appended claims. The invention itself, however, both as to its construction and its method of operation, together with additional objects and advantages thereof, will be best understood from the following description of the specific embodiments when read and understood in connection with the accompanying drawings, in which like reference characters designate the same or similar parts throughout the several views. Attention is called to the fact, however, that the drawings are illustrative only, and that changes may be made in the specific construction illustrated and described within the scope of the appended claims.

### BRIEF DESCRIPTION OF THE DRAWING FIGURES

FIG. 1 is a perspective view of one preferred embodiment of a sleeve of the present invention.

FIG. 2 is a perspective view of another preferred embodiment of a sleeve of the present invention.

FIG. 3 is a perspective view of a preferred embodiment of a strap of the present invention.

FIG. 4 is a cross-sectional view of the sleeve of the present invention.

### DETAILED DESCRIPTION OF THE PREFERRED EMBODIMENTS

Turning now descriptively to the drawings, in which similar reference characters denote similar elements throughout the several views, the Figures illustrate a tire traction strap of the present invention. With regard to the reference numerals used, the following numbering is used throughout the various drawing figures.

10 sleeve

20 straight middle portion of 10

30 angled end portion of 10

40 cleat on 20

50 stud on 20

60 terminal apertures of 10

70 strap

80 fastening means of 70

90 internal cavity of 10

100 traction member of 10

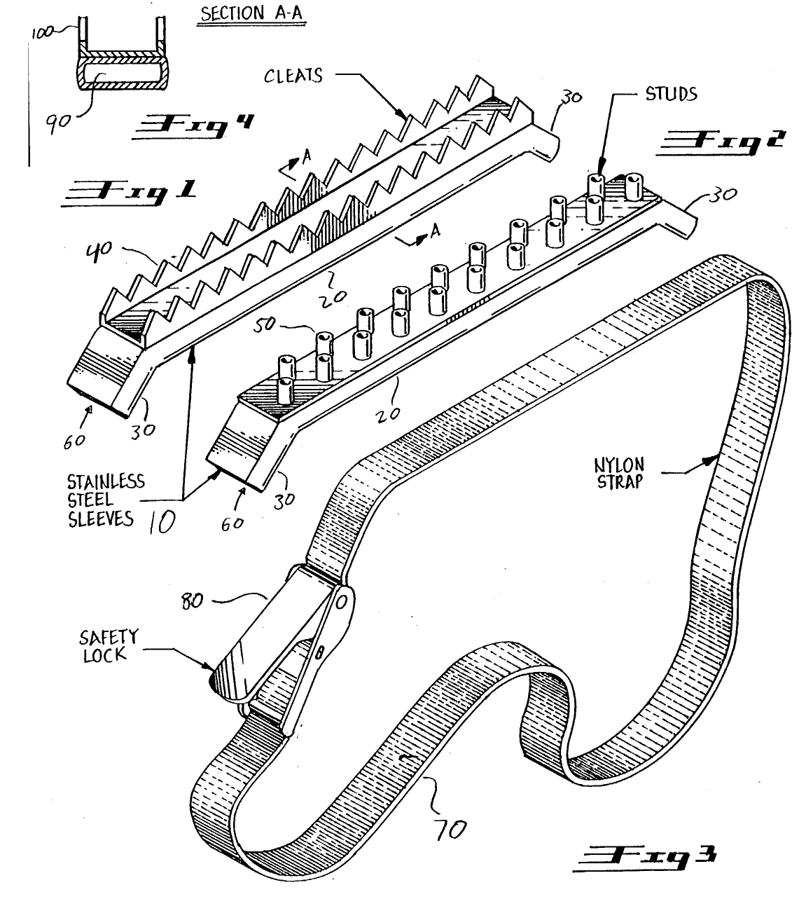

Referring now to the drawings, the figures illustrate the various parts of the tire traction strap of the present invention. FIG. 1 and FIG. 2 each show a preferred embodiment of the sleeve 10. The sleeve 10 is a hollow, elongate sleeve constructed from a durable, rigid material with a generally rectangular interior cross-section. The sleeve 10 has a tire contacting surface and an oppositely disposed road contacting surface for providing supplemental traction to the tire. The tire contacting surface will be generally flat and the road contacting surface includes one or more traction members 100. The sleeve has a straight central portion 20 and oppositely disposed angled end portions 30. At the terminus of each end portion, there is a terminal aperture 60 providing entry to the hollow interior portion 90 of the sleeve 10.

FIG. 3 illustrates the strap 70 which attaches the sleeve 10 to the tire. The strap 70 is sized to be received within the interior portion 90 of the sleeve 10. The strap has oppositely disposed end portions and includes fastening means 80 for securing the end portions together.

FIG. 4 shows a cross-section view of the central portion of the sleeve 10. An internal cavity 90 extends the length of the sleeve and a traction member 100 extends generally perpendicularly to the road contacting surface of the sleeve.

In practicing the invention, the strap 70 is passed through a wheel fello (an aperture in the wheel), which may or may not involve removal of a hubcap, and cross-sectionally encircles the tire transversely with respect to the periphery thereof. The strap 70 threads through the internal cavity 90 of the sleeve 10 which is placed transversely on the tire tread. The fastening means 80 is adapted to tightly secure the ends of the strap together, thus securing the sleeve to the tire. Accordingly, as the tire rotates, the traction member 100 engages the road surface via frictional and/or scraping engagement, thus enhancing traction of the tire with respect to the road surface.

The sleeve is manufactured of a durable, rigid material, preferably a metal such as steel. In alternative embodiments, modern polymeric materials such as plastic may be utilized also, provided they possess the requisite strength and durability to function as described herein.

The sleeves of the present invention include a straight middle region 20 and angled end portions 30. The straight portion is adapted to rest upon the tread of the tire to which the traction strap is attached, and the angled end portions turn inward toward the tire sidewall so that the sleeve, through the binding action of the strap, is held more securely to the tire, and is much more resistant to rolling over as the traction member engages the road surface. The angled end pieces also reduce stress on the strap, making the entire structure more durable. The edges of the sleeve which define the terminal apertures may also be beveled to further reduce strain on the strap. The angle of the end portions can vary significantly, but will be under 90° and preferably between about 20° and about 60°. Sleeves having end portions which are angled at 30° or 45° degrees, for example, should each be effective for most applications. With regard to the length of the angled portion, there can be significant variation, with lengths of between 1 and 3 inches being generally appropriate.

As tires are manufactured in standard widths, the sleeves can be sized to either fit a range of different tire sizes or to fit a specific tire width. It is anticipated that only two or three different sleeve sizes would be effective to accommodate most common automobile tire sizes. It can be readily appreciated, moreover, that the invention can be adapted for use with any wheel, tire and/or hub combination which includes wheel fellos of sufficient size to accommodate the strap. For example, in addition to automobile tires, the invention could be adapted to fit dune buggy, truck, tractor or ATV tires.

The straight portion of the sleeve bears one or more traction members 100. These can take any form which might be expected to provide traction, and will generally be perpendicular to the surface of the sleeve which contacts the road, and, upon contact therewith, perpendicular to the road surface itself. FIG. 1 illustrates a sleeve having two sets of cleats 40 running the length of the straight middle portion of the sleeve. FIG. 2 shows a sleeve having a number of studs 30 as the traction members. Other configurations may also be employed, for example, as FIG. 4 suggests, the traction members can be simply a straight, flat piece of material, such that the sleeve and traction member(s) together are similar in structure and function to a piece of rebar strapped to the tire. FIG. 4 shows two parallel traction members, but one, three or more could be used.

The sleeve in its final form will be essentially a single piece construction. FIG. 1, FIG. 2 and FIG. 4 show the sleeve as comprising two portions, a sleeve portion and a traction member portion, which have been permanently secured together. It can be appreciated that modern fabrication techniques allow for manufacture of the entire structure as a single piece of material, a preferred construction of the present invention. When assembled from component parts as shown in the Figures, the sleeve portion and the traction member portion are permanently affixed together such that they can be considered a single piece. For example, steel components could be welded, riveted, bolted or otherwise attached together, with welding preferred. Plastics can be affixed via use of an appropriate solvent, resulting in what can be considered a single piece of material.

The interior dimensions of the sleeve are sufficient to receive the strap. The strap should be nearly as wide as the width of the sleeve cavity, so that the strap, when tightened, can hold the sleeve very securely to the tire. As far as the actual dimensions of the sleeve are concerned, it should be of a width sufficient to avoid a tendency of the sleeve to roll while in use, which could also damage the tire. A width of one to two inches is expected to suffice for most applications, but deviations at either extreme may find utility, particularly with extremely large or small tires, or extreme applications. The strap will be subject to high shearing forces, and will necessarily be made of a material which is simultaneously strong, flexible and highly resistant to stretching and tearing. A preferred embodiment is made of synthetic fabric such as nylon, similar to the material that automotive seat belts are manufactured from. The strap should be manufactured of a material that will not scratch, mar, or otherwise damage the wheel, particularly any portions of the wheel comprising ornamental finishes, but which is strong enough to serve the purposes herein disclosed. Preferred embodiments of the strap comprise polymeric fibers such as nylon, natural fibers such as hemp, metal or metallic fibers such as carbon or steel, or polymer- or elastomer-coated metallic fabrics.

The ends of the strap are equipped with fastening means 80 which allows secure, simple, easy and rapid installation by a driver. A ratcheting connection is preferred, but other means such as seat belt-type clasps and other type connectors suitable for the material employed. The fastening means can be either integral to the strap itself, or permanently fastened to the opposing ends of the strap. The strap ends mutually engage each other via, for example, a ratcheting connection which is structured in the form of a known type which is commonly used in the fastener art. For example ramp-type connectors utilizing a series of closely spaced, saw tooth shaped, ramped serrations. Also preferred are ratchet tightening mechanisms, including those which can be tightened with a winding action, such mechanisms as are known in the fastener art.

In operation, when a driver encounters a surface in which he or she finds the vehicle stuck, the driver obtains one or more of the traction straps from a storage location in the vehicle and then proceeds to mount one or more thereof to the driving wheels affected. Mounting is performed by first locating a suitable aperture, or fello, through the wheel. In the event the hubcap prevents the use of a fello, the hubcap should be removed. Ideally, to save time in an emergency, the strap should be stored in the vehicle with the strap threaded through the sleeve. In this manner, the sleeve is first placed across the width of the affected tire, preferably directly above a wheel fello. The end of the strap which extends from the inside end of the sleeve is then passed through the nearest fello. Finally, the two ends of the strap are tightened and secured together. The strap should be reasonably tight on the tire. Optionally, additional traction straps can be rapidly affixed to other locations on the same tire, and to one or more other tires, as needed. The driver then causes the drive wheels to rotate at a speed reasonably calculated to cause extrication from the problem surface area. Once extrication has been achieved, the driver may either remove the one or more traction straps, or drive off with the tractions straps remaining on the tire to prevent reoccurrence of the original loss of traction.

Traction straps of the invention offer a number of advantages, particularly when compared to previously-known devices. For example, they are easy to installed without requiring the installer to lie down in the mud or snow or otherwise dirty, cold, wet, or unpleasant conditions in which an automobile has become stranded. Typically they may be installed in a matter of no more than 15 to 30 seconds each, using common tools or no tools at all. They are removable and reusable, and have no required orientation for the sleeve in order to function properly. They may be stored and transported easily, typically in an existing jack or spare tire compartment, where they are out of the way and take up no space needed for the storage or transportation of other items. They are very strong, and can accomplish the important purpose of moving a vehicle through a relatively short distance, with one, two or three of them installed on a drive wheel. The portions in contact with ornamental parts of the wheel are made from non-abrasive and non-marring materials and may be used without damage to a vehicle. And in comparison with most prior art devices, they are extremely economical to make, use, maintain, and install. One embodiment of the present invention is a kit intended for storage in a vehicle, the kit containing two or more traction straps ready for immediate use, that is, with the strap threaded through the sleeve. The kit further contains an indication of which size tires the packaged device is appropriate for, and instructions for use.

It will be understood that each of the elements described above, or two or more together, may also find a useful application in other types of applications differing from the type described above. While the invention has been illustrated and described as embodied in an automobile tire traction device, it is not intended to be limited to the details shown, since it will be understood that various omissions, modifications, substitutions and changes in the forms and details of the formulation illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of this invention.

What is claimed as new and desired to be protected by Letters Patent is set forth in the appended claims.

I claim:

1. A traction device adapted to be removably affixed to a tire mounted on a wheel, comprising:
a rigid elongate sleeve having a generally rectangular hollow cross section, a straight central region, end portions which are acutely angled in the same direction from the straight central region, and apertures at opposing ends thereof providing passage completely through the length of the sleeve;
a traction member affixed to the straight cenral region of the sleeve, opposite from the side toward which the end portions are angled, and generally perpendicular thereto;
a strap having opposing ends, the strap sized to be received through the sleeve apertures and the hollow cross section of the sleeve; and
fastening means affixed to each end of the strap such that the ends are removably and securely connectable.

2. The traction device according to claim 1, wherein the sleeve is manufactured from metal.

3. The traction device according to claim 2, wherein the sleeve is manufactured from aluminum or steel.

4. The traction device according to claim 1, wherein the sleeve is manufactured from plastic.

5. The traction device according to claim 3, wherein the angled end portions of the sleeve are angled from about 20 to about 60 degrees from the straight central region of the sleeve.

6. The traction device according to claim 5, wherein the angled end portions of the sleeve are angled from about 30 to about 45 degrees from the straight central region of the sleeve.

7. The traction device according to claim 5, wherein the traction member is securely and permanently affixed to the straight central region of the sleeve.

8. The traction device according to claim 5, wherein the traction member is integral to the sleeve.

9. The traction device according to claim 5, wherein the traction member comprises at least one rigid bar which is perpedicular to the road contacting surface of the straight central region of the sleeve.

10. The traction device according to claim 5, wherein the traction member comprises a plurality of cleats.

11. The traction device according to claim 5, wherein the traction member comprises a plurality of studs.

12. The traction device according to claim 1, wherein the apertures have beveled edges.

13. The traction device according to claim 1, wherein the strap is manufactured of nylon, hemp, metal, metallic fiber, or polymer- or elastomer-coated metallic fabric.

14. The traction device according to claim 13, wherein the strap is manufactured of nylon.

15. The traction device according to claim 13, wherein the strap is between one-half and two inches in width.

16. The traction device according to claim 15, wherein the strap is about one inche in width.

17. The traction device according to claim 1, wherein the fastening means comprises one or more ramps, clasps, buckles, hook and loop-type fasteners, ratchets and dials.

18. An emergency tire traction kit comprising:
a traction device adapted to be removably affixed to a tire mounted on a wheel, the traction device having a rigid elongate sleeve having a generally rectangular hollow cross section, a straight central region, end portions which are acutely angled in the same direction from the straight central region, and apertures at opposing ends thereof providing passage completely through the length of the sleeve; a traction member affixed to the straight central region of the sleeve, opposite from the side toward which the end portions are angled, and generally perpendicular thereto; a strap having opposing ends, the strap sized to be received through the sleeve apertures and the hollow cross section of the sleeve; and fastening means affixed to each end of the strap such that the ends are removably and securely connectable;
instructions for use; and
a tire size indicator.

19. The emergency tire traction kit according to claim 18, further comprising multiple traction devices and a pair of gloves.

20. A method for providing temporary supplemental traction to a tire mounted on a felloed wheel, the tire having a road contacting surface and sidewalls, comprising:
passing a first end of a strap through a fello of a wheel and fastening the first end of the strap to a second end of the strap, wherein the strap passes through a rigid elongate sleeve having a generally rectangular hollow cross section, a straight central region, end portions which are acutely angled in the same direction from the straight central region, and apertures at opposing ends thereof providing passage completely through the length of the sleeve, and wherein a traction member is affixed to the straight cenral region of the sleeve, opposite from the side toward which the end portions are angled, and generally perpendicular thereto, with the straight central region of the sleeve placed across a road contacting surface of the tire with the angled end portions angled toward the sidewalls of the tire.
